(19) United States
(12) Patent Application Publication
(10) Pub. No.: US 2011/0149111 A1
(43) Pub. Date: Jun. 23, 2011

(54) CREATING AN IMAGE USING STILL AND PREVIEW

(76) Inventors: Wayne E. Prentice, Honeoye Falls, NY (US); Aaron T. Deever, Pittsford, NY (US)

(21) Appl. No.: 12/644,039

(22) Filed: Dec. 22, 2009

(51) Int. Cl. H04N 5/235

(52) U.S. Cl. 348/229.1; 348/E05.037

(57) ABSTRACT

A method for improving the dynamic range of a captured digital image, including acquiring at least one image from the live view image stream, wherein each acquired live view image has an effective exposure and a first resolution; capturing at least one still image at an effective exposure different than each of the acquired live view images, and at a resolution higher than the first resolution; and combining the at least one live view image and the at least one still image.

### CROSS REFERENCE TO RELATED APPLICATIONS

Reference is made to commonly assigned U.S. Pat. No. ______ (Docket 96037) filed Dec. 22, 2009 by Wayne E. Prentice, entitled “Method for Creating High Dynamic Range Image”, the disclosure of which is herein incorporated by reference.

### FIELD OF THE INVENTION

The invention pertains to generating an improved image from multiple images. More specifically, multiple images are used to form a high resolution image having increased dynamic range.

### BACKGROUND OF THE INVENTION

Image sensing devices, such as a charge-coupled device (CCD), are commonly found in such products as digital cameras, scanners, and video cameras. These image sensing devices have a very limited dynamic range when compared to traditional negative film products. A typical image sensing device has a dynamic range of about 5 stops. This means that the exposure for a typical scene must be determined with a fair amount of accuracy in order to avoid clipping the signal. In addition, oftentimes the scene has a very wide dynamic range as a result of multiple illuminants (e.g. frontlit and backlit portions of a scene). In the case of a wide dynamic range scene, choosing an appropriate exposure for the subject often necessitates clipping data in another part of the image. Thus, the inferior dynamic range of an image sensing device relative to silver halide media results in lower image quality for images obtained by an image sensing device.

Methods to increase the dynamic range of images acquired by an image sensing device would allow such images to be rebalanced to achieve a more pleasing rendition of the image. Also, images with increased dynamic range would allow for more pleasing contrast improvements, such as described by Lee et al. in commonly assigned U.S. Pat. No. 5,012,333.

One method used for obtaining improved images with an image sensing device is exposure bracketing, whereby multiple still images of the same resolution are captured at a range of different exposures, and one of the images is selected as a best overall exposure. This technique, however, does not increase the dynamic range of any individual image captured by the image sensing device.

One method for obtaining an image with increased dynamic range is by capturing multiple still images of the same resolution at different exposures, and combining the images into a single output image having increased dynamic range. This approach is described by Mann in commonly assigned U.S. Pat. No. 5,828,793 and by Ikeda in commonly assigned U.S. Pat. No. 6,040,858. This approach often requires a separate capture mode and processing path in a digital camera. Additionally, the temporal proximity of the multiple captures is limited by the rate at which the images can be read out from the image sensor. Greater temporal disparity among captures increases the likelihood of motion existing among the captures, whether camera motion related to hand jitter, or scene motion resulting from objects moving within the scene. Motion increases the difficulty in merging multiple images into a single output image.

Another method for obtaining an image with increased dynamic range which addresses the issue of motion existing among multiple images is the simultaneous capture of multiple images having different exposures. The images are subsequently combined into a single output image having increased dynamic range. This capture process can be achieved through the use of multiple imaging paths and sensors. However, this solution incurs extra cost in the form of multiple imaging paths and sensors. It also introduces a correspondence problem among the multiple images, as the sensors are not co-located and thus generate images with different perspectives. Alternatively, a beam-splitter can be used to project incident light onto multiple sensors within a single image capture device. This solution incurs extra cost in the form of the beam-splitter and multiple sensors, and also reduces the amount of light available to any individual image sensor.

Another method for obtaining an image with increased dynamic range is through the use of an image sensor having pixels with a standard response to light exposure and pixels having a non-standard response to light exposure. Such a solution is described by Gallagher et al. in commonly assigned U.S. Pat. No. 6,909,461. Such a sensor has inferior performance, however, for scenes that do not exhibit high dynamic range characteristics, as the pixels with a slower, non-standard response have poorer signal-to-noise performance than pixels with a standard response.

Another method for obtaining an image with increased dynamic range is through the use of an image sensor programmed to read out and store pixels within the image sensor at a first exposure while continuing to expose the image sensor to light. Such a solution is described by Ward et al. in commonly assigned U.S. Pat. No. 7,616,256. In one example, pixels from a CCD are read into light-shielded vertical registers after a first exposure time, and exposure of the image sensor continues until a second exposure time is completed. While this solution allows multiple readouts of individual pixels from the image sensor with minimal time between the exposures, it has the drawback of requiring specialized hardware to read the data off of the sensor.

Therefore, a need in the art exists for an improved solution to combining multiple images to form an image having increased dynamic range, without requiring special hardware or additional image sensors, without sacrificing performance for scenes not requiring high dynamic range, without requiring a separate capture mode, and with minimal time between the multiple exposures.

### SUMMARY OF THE INVENTION

The object of this invention is to produce an image having increased dynamic range using at least one live view image and at least one still image. The object is achieved by a method for improving the dynamic range of a captured digital image, the method comprising the steps of (a) acquiring at least one image from the live view image stream, wherein each acquired live view image has an effective exposure and a first resolution; (b) capturing at least one still image at an effective exposure different than each of the acquired live view images, and at a resolution higher than the first resolution; and (c) combining the at least one live view image and the at least one still image.

An advantage of the present invention is that an image having increased dynamic range can be produced without special hardware or additional image sensors.

A further advantage of the present invention is that an image having increased dynamic range can be produced without sacrificing performance for scenes not requiring high dynamic range.

A further advantage of the present invention is that an image having increased dynamic range can be produced without requiring a separate capture mode.

A still further advantage of the present invention is that an image having increased dynamic range can be produced with minimal time between the multiple exposures.

This and other aspects, objects, features, and advantages of the present invention will be more clearly understood and appreciated from a review of the following detailed description of the preferred embodiments and appended claims, and by reference to the accompanying drawings.

### BRIEF DESCRIPTION OF THE DRAWINGS

FIG. 1 is a block diagram of a digital still camera system for use with the processing methods of the current invention;

FIG. 2 (prior art) is an illustration of a Bayer pattern on an image sensor;

FIG. 3a is a flow chart of an embodiment of the present invention;

FIG. 3b is a flow chart of an embodiment of the present invention;

FIG. 4 is a flow chart of a method for combining live view and still images of the present invention;

FIG. 5 is a flow chart of a method for combining live view and still images of the present invention;

FIG. 6 is a flow chart of a method for combining a live view image and a representative live view image of the present invention;

FIG. 7 is a flow chart of a method for combining a scaled live view image and a representative live view image of the present invention; and

FIG. 8 is a flow chart of a method for combining a scaled live view image and a representative live view image of the present invention.

### DETAILED DESCRIPTION OF THE INVENTION

Because digital cameras employing imaging devices and related circuitry for signal capture and correction and for exposure control are well known, the present description will be directed in particular to elements forming part of, or cooperating more directly with, method and apparatus in accordance with the present invention. Elements not specifically shown or described herein are selected from those known in the art. Certain aspects of the embodiments to be described are provided in software. Given the system as shown and described according to the invention in the following materials, software not specifically shown, described or suggested herein that is useful for implementation of the invention is conventional and within the ordinary skill in such arts.

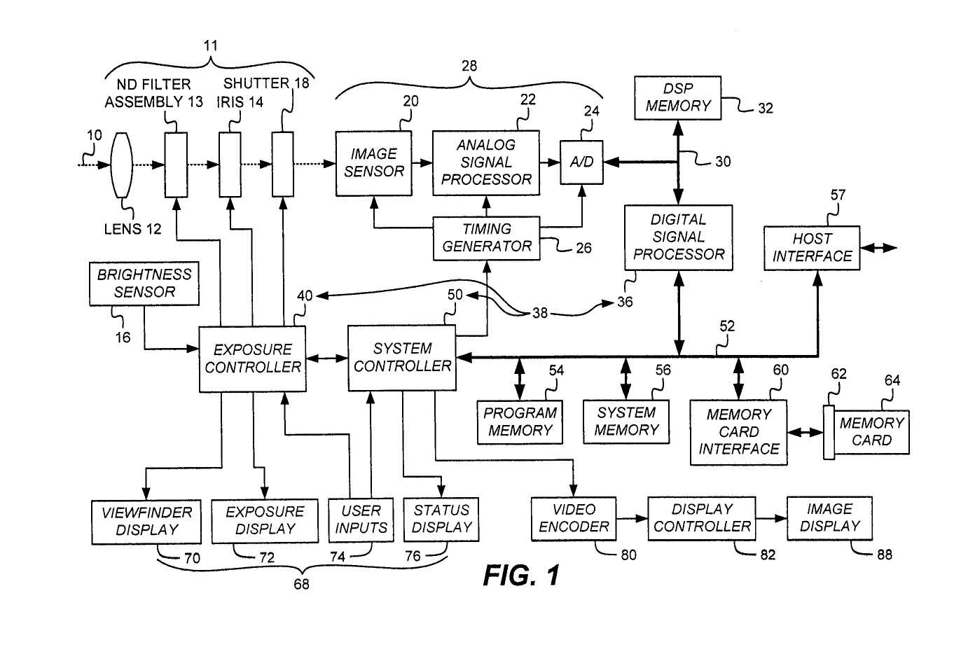

Turning now to FIG. 1, a block diagram of an image capture device shown as a digital camera embodying the present invention is shown. Although a digital camera will now be explained, the present invention is clearly applicable to other types of image capture devices, such as imaging sub-systems included in non-camera devices such as mobile phones and automotive vehicles, for example. Light 10 from the subject scene is input to an imaging stage 11, where the light is focused by lens 12 to form an image on solid-state image sensor 20. Image sensor 20 converts the incident light to an electrical signal by integrating charge for each picture element (pixel). The image sensor 20 of the preferred embodiment is a charge coupled device (CCD) type or an active pixel sensor (APS) type. (APS devices are often referred to as CMOS sensors because of the ability to fabricate them in a Complementary Metal Oxide Semiconductor process). The sensor includes an arrangement of color filters, as described in more detail subsequently.

The amount of light reaching the sensor 20 is regulated by an iris block 14 that varies the aperture and the neutral density (ND) filter block 13 that includes one or more ND filters interposed in the optical path. Also regulating the overall light level is the time that the shutter block 18 is open. The exposure controller block 40 responds to the amount of light available in the scene as metered by the brightness sensor block 16 and controls all three of these regulating functions.

The analog signal from image sensor 20 is processed by analog signal processor 22 and applied to analog to digital (A/D) converter 24 for digitizing the sensor signals. Timing generator 26 produces various clocking signals to select rows and pixels and synchronizes the operation of analog signal processor 22 and A/D converter 24. The image sensor stage 28 includes the image sensor 20, the analog signal processor 22, the A/D converter 24, and the timing generator 26. The functional elements of image sensor stage 28 are separately fabricated integrated circuits, or they are fabricated as a single integrated circuit as is commonly done with CMOS image sensors. The resulting stream of digital pixel values from A/D converter 24 is stored in memory 32 associated with digital signal processor (DSP) 36.

Digital signal processor 36 is one of three processors or controllers in this embodiment, in addition to system controller 50 and exposure controller 40. Although this distribution of camera functional control among multiple controllers and processors is typical, these controllers or processors are combinable in various ways without affecting the functional operation of the camera and the application of the present invention. These controllers or processors can comprise one or more digital signal processor devices, microcontrollers, programmable logic devices, or other digital logic circuits. Although a combination of such controllers or processors has been described, it should be apparent that one controller or processor is preferably designated to perform all of the needed functions. All of these variations can perform the same function and fall within the scope of this invention, and the term “processing stage” will be used as needed to encompass all of this functionality within one phrase, for example, as in processing stage 38 in FIG. 1.

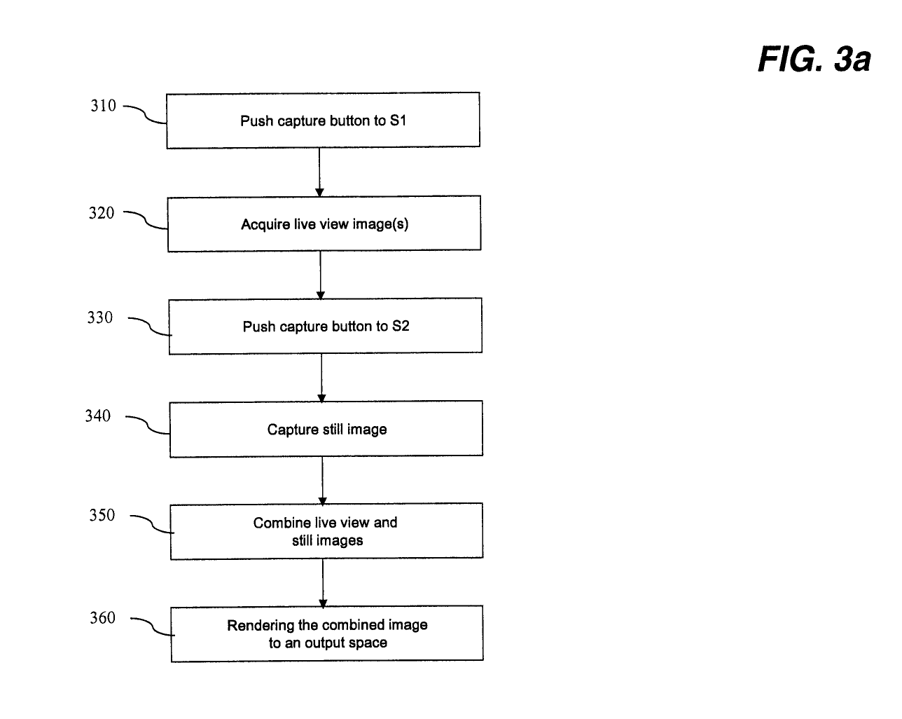

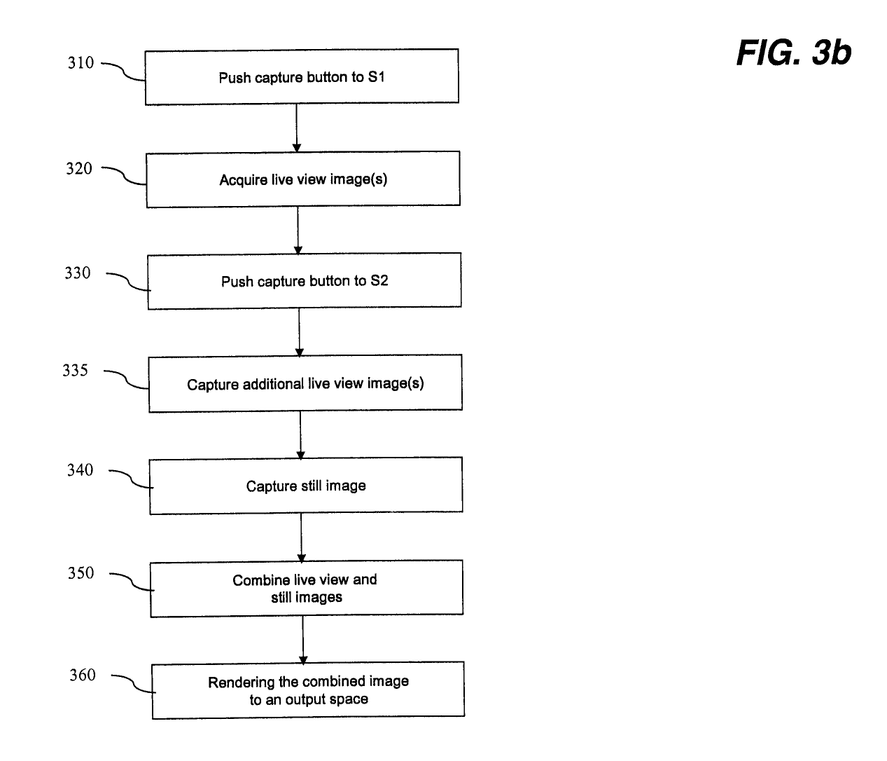

In the illustrated embodiment, DSP 36 manipulates the digital image data in its memory 32 according to a software program permanently stored in program memory 54 and copied to memory 32 for execution during image capture. DSP 36 executes the software needed for practicing image processing shown in FIGS. 3a and 3b. Memory 32 includes any type of random access memory, such as SDRAM. A bus 30 comprising a pathway for address and data signals connects DSP 36 to its related memory 32, A/D converter 24 and other related devices.

System controller 50 controls the overall operation of the camera based on a software program stored in program memory 54, which can include Flash EEPROM or other nonvolatile memory. This memory can also be used to store image sensor calibration data, user setting selections and other data which must be preserved when the camera is turned off. System controller 50 controls the sequence of image capture by directing exposure controller 40 to operate the lens 12, ND filter 13, iris 14, and shutter 18 as previously described, directing the timing generator 26 to operate the image sensor 20 and associated elements, and directing DSP 36 to process the captured image data. After an image is captured and processed, the final image file stored in memory 32 is transferred to a host computer via interface 57, stored on a removable memory card 64 or other storage device, and displayed for the user on image display 88.

A bus 52 includes a pathway for address, data and control signals, and connects system controller 50 to DSP 36, program memory 54, system memory 56, host interface 57, memory card interface 60 and other related devices. Host interface 57 provides a high-speed connection to a personal computer (PC) or other host computer for transfer of image data for display, storage, manipulation or printing. This interface is an IEEE1394 or USB2.0 serial interface or any other suitable digital interface. Memory card 64 is typically a Compact Flash (CF) card inserted into socket 62 and connected to the system controller 50 via memory card interface 60. Other types of storage that are used include without limitation PC-Cards, MultiMedia Cards (MMC), or Secure Digital (SD) cards.

Processed images are copied to a display buffer in system memory 56 and continuously read out via video encoder 80 to produce a video signal. This signal is output directly from the camera for display on an external monitor, or processed by display controller 82 and presented on image display 88. This display is typically an active matrix color liquid crystal display (LCD), although other types of displays are used as well.

The user interface 68, including all or any combination of viewfinder display 70, exposure display 72, status display 76 and image display 88, and user inputs 74, is controlled by a combination of software programs executed on exposure controller 40 and system controller 50. User inputs 74 typically include some combination of buttons, rocker switches, joysticks, rotary dials or touch screens. Exposure controller 40 operates light metering, exposure mode, autofocus and other exposure functions. The system controller 50 manages the graphical user interface (GUI) presented on one or more of the displays, e.g., on image display 88. The GUI typically includes menus for making various option selections and review modes for examining captured images.

Exposure controller 40 accepts user inputs selecting exposure mode, lens aperture, exposure time (shutter speed), and exposure index or ISO speed rating and directs the lens and shutter accordingly for subsequent captures. Brightness sensor 16 is employed to measure the brightness of the scene and provide an exposure meter function for the user to refer to when manually setting the ISO speed rating, aperture and shutter speed. In this case, as the user changes one or more settings, the light meter indicator presented on viewfinder display 70 tells the user to what degree the image will be over or underexposed. In an automatic exposure mode, the user changes one setting and the exposure controller 40 automatically alters another setting to maintain correct exposure, e.g., for a given ISO speed rating when the user reduces the lens aperture, the exposure controller 40 automatically increases the exposure time to maintain the same overall exposure.

The ISO speed rating is an important attribute of a digital still camera. The exposure time, the lens aperture, the lens transmittance, the level and spectral distribution of the scene illumination, and the scene reflectance determine the exposure level of a digital still camera. When an image from a digital still camera is obtained using an insufficient exposure, proper tone reproduction can generally be maintained by increasing the electronic or digital gain, but the image will contain an unacceptable amount of noise. As the exposure is increased, the gain is decreased, and therefore the image noise can normally be reduced to an acceptable level. If the exposure is increased excessively, the resulting signal in bright areas of the image can exceed the maximum signal level capacity of the image sensor or camera signal processing. This can cause image highlights to be clipped to form a uniformly bright area, or to bloom into surrounding areas of the image. It is important to guide the user in setting proper exposures. An ISO speed rating is intended to serve as such a guide. In order to be easily understood by photographers, the ISO speed rating for a digital still camera should directly relate to the ISO speed rating for photographic film cameras. For example, if a digital still camera has an ISO speed rating of ISO 200, then the same exposure time and aperture should be appropriate for an ISO 200 rated film/process system.

The ISO speed ratings are intended to harmonize with film ISO speed ratings. However, there are differences between electronic and film-based imaging systems that preclude exact equivalency. Digital still cameras can include variable gain, and can provide digital processing after the image data has been captured, enabling tone reproduction to be achieved over a range of camera exposures. Because of this flexibility, digital still cameras can have a range of speed ratings. This range is defined as the ISO speed latitude. To prevent confusion, a single value is designated as the inherent ISO speed rating, with the ISO speed latitude upper and lower limits indicating the speed range, that is, a range including effective speed ratings that differ from the inherent ISO speed rating. With this in mind, the inherent ISO speed is a numerical value calculated from the exposure provided at the focal plane of a digital still camera to produce specified camera output signal characteristics. The inherent speed is usually the exposure index value that produces peak image quality for a given camera system for normal scenes, where the exposure index is a numerical value that is inversely proportional to the exposure provided to the image sensor.

The foregoing description of a digital camera will be familiar to one skilled in the art. It will be obvious that there are many variations of this embodiment that can be selected to reduce the cost, add features, or improve the performance of the camera. For example, an autofocus system could be added, or the lens is detachable and interchangeable. It will be understood that the present invention is applied to any type of digital camera or, more generally, digital image capture apparatus, where alternative modules provide similar functionality.

Given the illustrative example of FIG. 1, the following description will then describe in detail the operation of this camera for capturing images according to the present invention. Whenever general reference is made to an image sensor in the following description, it is understood to be representative of the image sensor 20 from FIG. 1. Image sensor 20 shown in FIG. 1 typically includes a two-dimensional array of light sensitive pixels fabricated on a silicon substrate that convert incoming light at each pixel into an electrical signal that is measured. In the context of an image sensor, a pixel (a contraction of “picture element”) refers to a discrete light sensing area and charge shifting or charge measurement circuitry associated with the light sensing area. In the context of a digital color image, the term pixel commonly refers to a particular location in the image having associated color values. The term color pixel will refer to a pixel having a color photoresponse over a relatively narrow spectral band. The terms exposure duration and exposure time are used interchangeably.

As sensor 20 is exposed to light, free electrons are generated and captured within the electronic structure at each pixel. Capturing these free electrons for some period of time and then measuring the number of electrons captured, or measuring the rate at which free electrons are generated, can measure the light level at each pixel. In the former case, accumulated charge is shifted out of the array of pixels to a charge-to-voltage measurement circuit as in a charge-coupled device (CCD), or the area close to each pixel can contain elements of a charge-to-voltage measurement circuit as in an active pixel sensor (APS or CMOS sensor).

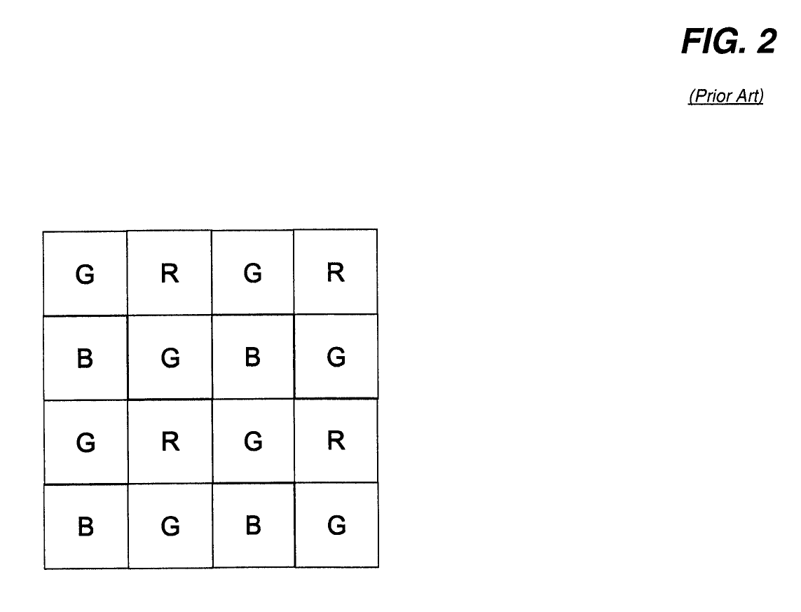

In order to produce a color image, the array of pixels in an image sensor typically has a pattern of color filters placed over them. FIG. 2 shows a pattern of red (R), green (G), and blue (B) color filters that is commonly used. This particular pattern is commonly known as a Bayer color filter array (CFA) after its inventor Bryce Bayer as disclosed in U.S. Pat. No. 3,971,065. This pattern is effectively used in image sensors having a two-dimensional array of color pixels. As a result, each pixel has a particular color photoresponse that, in this case, is a predominant sensitivity to red, green or blue light. Another useful variety of color photoresponses is a predominant sensitivity to magenta, yellow, or cyan light. In each case, the particular color photoresponse has high sensitivity to certain portions of the visible spectrum, while simultaneously having low sensitivity to other portions of the visible spectrum.

An image captured using an image sensor having a two-dimensional array with the CFA of FIG. 2 has only one color value at each pixel. In order to produce a full color image, there are a number of techniques for inferring or interpolating the missing colors at each pixel. These CFA interpolation techniques are well known in the art and reference is made to the following patents: U.S. Pat. No. 5,506,619; U.S. Pat. No. 5,629,734; and U.S. Pat. No. 5,652,621.

FIG. 3a illustrates a flow diagram according to an embodiment of the present invention. In step 310, the operator begins the acquisition process by pushing the capture button on the camera from the S0 position (undepressed position) to the S1 position (partially depressed position) thereby sending a partially-depressed-capture-button signal to the system controller 50 in the camera, as the operator composes the image. The system controller 50 then instructs the camera to begin acquiring and storing live view images 320, using available DSP memory 32. It should be noted that at the same time, the system controller 50 in the camera would also typically complete autofocus and autoexposure. When the moment of acquisition is identified by the operator, the operator pushes the capture button from S1 to S2 (fully depressed position) thereby sending a fully-depressed-capture button signal to the system controller 50 in the camera, as shown in Step 330. At this point, in Step 340, the system controller 50 instructs the camera to stop continuous acquisition or capture of the live view images and to initiate the capture of a still image having a spatial resolution greater than the live view images. In Step 350 the live view images and still image are combined to form an improved still image having higher dynamic range than the original captured still image. Finally, in Step 360, the improved still image is rendered to an output space.

The live view images acquired in Step 320 can be from the live view image stream, such as often displayed on the camera LCD display 88. Such images are typically captured and displayed at 30 frames per second at a spatial resolution of 320 columns by 240 rows (QVGA resolution), or at 640 columns by 480 rows (VGA resolution). This spatial resolution is not limiting, however, and the live view images can be captured at a greater spatial resolution. The live view images can also be displayed at a greater spatial resolution. The frequency at which the live view images can be captured and read out from the sensor is inversely proportional to the spatial resolution of the live view images.

Each live view image acquired in Step 320 is initially captured with a certain effective exposure. As defined herein, effective exposure is defined as the exposure time of the image sensor for the given image, scaled by any binning factor used when reading out the image data from the sensor. For example, an image sensor using an exposure of 1/30 second for a live view image, along with a binning factor of 9×, generates an effective exposure of 9/30, or equivalently 3/10 second for the live view image. In this context, binning refers to the accumulation of charge from neighboring pixels prior to read out, and the binning factor refers to how many pixels have their charge accumulated into a single value which is read out. Binning typically occurs by accumulating charge from like pixels within the CFA pattern on the image sensor. For example, in FIG. 2, a binning factor of 4× could be achieved by accumulating the charge from all 4 red pixels shown in the illustration to form a single red pixel, and by similarly accumulating charge for blue pixels and for green pixels. Note that there are twice as many green pixels as blue or red in a Bayer pattern, and they would be accumulated in two independent groups to form two separate binned pixels.

The still image captured in Step 340 is of greater spatial resolution than the live view images acquired during Step 320. Often the still image has the full spatial resolution of the image sensor 20. The still image is captured at an effective exposure that is different than the effective exposure corresponding to any live view image. The difference in effective exposure allows the subsequent generation of a high dynamic range image in Step 350.

The acquisition of live view images can also occur outside of S1. While the camera is in the S0 position, live view images can be acquired as in Step 320. The acquisition of live view images can also continue through a transition from S0 to S1, or through a transition from S1 to S0.

The acquired live view images have effective exposure that is different from the effective exposure of the still image. In one embodiment of the present invention, the acquired live view images have an effective exposure that is less than the effective exposure of the still image. Conceptually, in this scenario the still image contains regions that have saturated from over-exposure to light. The live view images with lower effective exposure provide additional information in these regions if the corresponding pixels are not saturated as well.

In another embodiment of the present invention, the acquired live view images have an effective exposure that is greater than the effective exposure of the still image. Conceptually, in this scenario the still image contains regions that are dark and have low signal-to-noise ratio. These dark regions can be brightened by applying a digital gain factor to those pixel values, or by applying a tone scaling operation that brings out details in the shadows, but this increases the noise along with the signal. The live view images with greater effective exposure provide additional information with reduced noise in these regions. The improved signal-to-noise performance in the dark regions allows these regions to be lightened with less risk of objectionable noise.

In another embodiment of the present invention, at least one acquired live view image has an effective exposure that is less than the effective exposure of the still image, and at least one acquired live view image has an effective exposure that is greater than the effective exposure of the still image. Conceptually, in this scenario it is possible to improve the quality of the still image in both dark regions and saturated regions using the additional information provided in the live view images.

When using multiple images to generate an image with increased dynamic range, it is preferable that the multiple images capture the same scene. To achieve this, the multiple images can be acquired with as little temporal disparity among the images as possible. This minimizes the potential for any changes in the scene that result from events such as camera motion, object motion, or lighting changes. In general, the live view image stream produces a continuous stream of live view images, followed by the capture of a still image. In order to minimize the temporal disparity between the acquired live view images and the still image, the most recently captured images from the live view image stream can be acquired and stored, continuously replacing older live view images.

In the case that live view images with multiple different effective exposures are acquired and stored, it is necessary to change the effective exposure of the images in the live view image stream at some instant. One method for acquiring live view images having two effective exposures is to capture live view images having alternating effective exposures. Such a strategy always guarantees that when the still image is captured, the two most recently captured live view images include one having the first effective exposure, and the other having the second effective exposure. The drawback of such a strategy is that it can be difficult to display live view images having alternating effective exposures on the back of the camera without visual artifacts. In some cases, however, the live view images can be captured at a rate exceeding the rate at which live view images are displayed on the back of the camera. For example, if live view images are captured at 60 frames per second, and displayed on the back of the camera at 30 frames per second, it is only necessary to have live view images corresponding to a single effective exposure used for display on the back of the camera, eliminating the concern of visual artifacts.

FIG. 3b illustrates an additional method for acquiring live view images having different effective exposures. In step 310, the operator begins the acquisition process by pushing the capture button on the camera from the S0 position (undepressed position) to the S1 position (partially depressed position) thereby sending a partially-depressed-capture-button signal to the system controller 50 in the camera, as the operator composes the image. The system controller 50 then instructs the camera to begin acquiring and storing live view images 320, using available DSP memory 32. The acquired live view images can correspond to a single effective exposure. When the moment of acquisition is identified by the operator, the operator pushes the capture button from S1 to S2 (fully depressed position) thereby sending a fully-depressed-capture button signal to the system controller 50 in the camera, as shown in Step 330. At this point, in Step 335, the system controller 50 instructs the camera to capture at least one additional live view image at a different effective exposure than previously acquired. After the one or more additional live view images are captured, the system controller 50 instructs the camera in Step 340 to stop continuous acquisition or capture of the live view images and to initiate the capture of a still image having a spatial resolution greater than the live view images. In Step 350 the live view images and still image are combined to form an improved still image having higher dynamic range than the original captured still image. Finally, in Step 360, the improved still image is rendered to an output space.

By delaying the capture of a live view image having the second effective exposure until after the user has pushed the capture button from S1 to S2, the live view images captured prior to S2 can be displayed on the back of the camera without concern for visual artifacts resulting from varying effective exposure of the live view images.

In all cases, the live view images can be captured automatically, without the user required to switch camera modes, or manually set the exposure for the live view images.

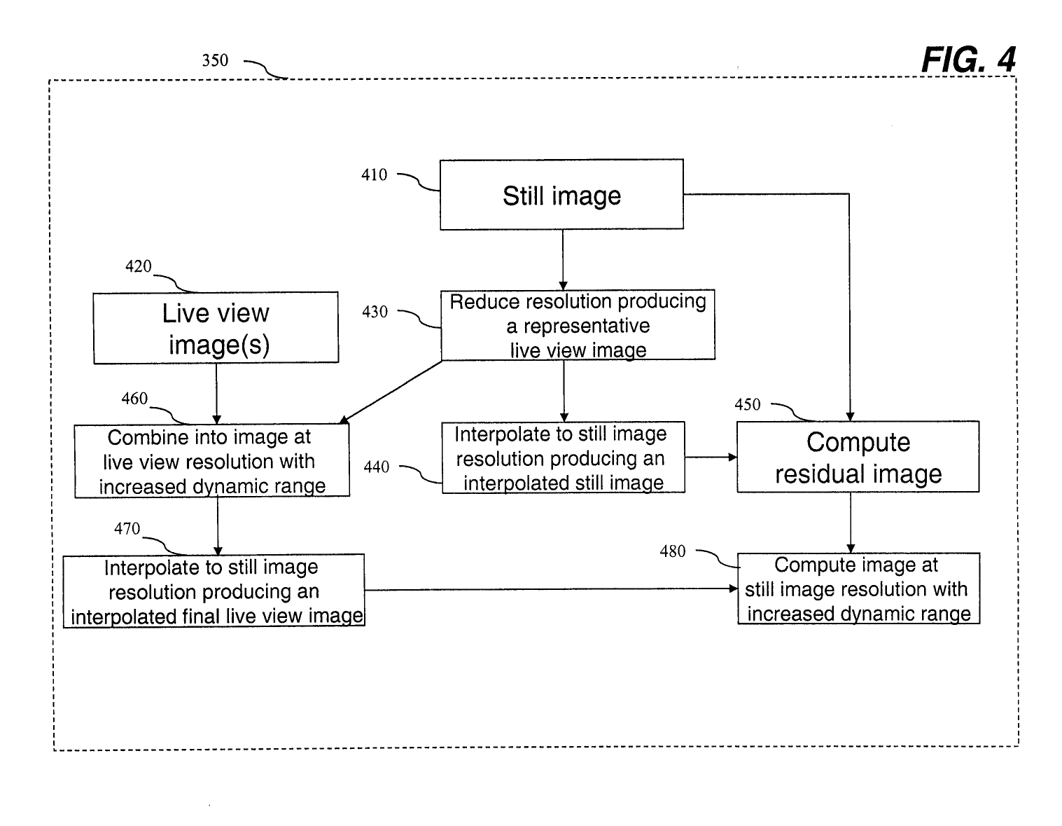

FIG. 4 describes in more detail the step of combining the live view and still images (Step 350 from FIG. 3a and FIG. 3b) according to one embodiment of the present invention. The step of combining the live view and still images begins with a still image 410 and at least one live view image 420. Initially, the still image is reduced in resolution 430. It is noted that as defined herein “representative live view image” is the image produced as a result of step 430. This step can comprise pixel combining, decimation and cropping. In a preferred embodiment, the step of reducing the resolution of the still image is designed to mimic the steps used by the camera to generate the live view images.

An example of a reduction of resolution is as follows for a 12 megapixel Bayer pattern sensor with 4032 columns and 3034 rows. The still image is reduced to generate a 1312 by 506 live view image, such as generated while the camera button is pressed to the S1 position. The 4032 columns by 3034 rows are digitally combined by a factor of 3 in each dimension. This can be achieved by combining the pixel values of corresponding Bayer pattern pixel locations. Nine blue pixel values are combined to generate one combined blue pixel value. Similarly nine red pixel values are combined to generate one combined red pixel value. Nine green pixels values on the same rows as red pixels are combined to form a combined green pixel value. And nine green pixels on the same rows as blue pixels are combined to form another combined green pixel value. The combined pixel values can be normalized by dividing the combined pixel value by the number of pixels contributing to the value. The combination step can also discard some of the pixel values. For instance, only six of the nine pixel values can be used when forming the combined pixel value. The resulting image has resolution 1342 by 1010 and retains a Bayer pattern. To reduce the vertical resolution further by a factor of two while maintaining an image with Bayer pattern structure, every other pair of rows is discarded. This results in a Bayer pattern image having resolution 1342 by 506. Finally, 16 columns are cropped from the left of the image, and 14 columns are cropped from the right of the image to generate an image with resolution 1312 by 506 corresponding to a live view image.

The representative live view image is subsequently spatially interpolated back to the resolution of the original still image 440. This process generates an interpolated still image. In the case that some rows or columns of the original still image are cropped during the formation of the representative live view image, the interpolation step only generates an interpolated image with the same resolution as the cropped still image. In a preferred embodiment, bicubic interpolation is used to generate the interpolated still image. Those skilled in the art will recognize, however, that there exist many suitable interpolation techniques to generate an interpolated still image.

In step 450, the interpolated still image is subtracted from the original still image to generate a residual image. If the original and interpolated still images are of different sizes, the residual image can be the same size as the interpolated still image, and additional rows/columns from the original still image can be ignored. Alternatively, the residual image can be the same size as the original still image, and the residual image can have values equal to the original still image at any locations outside the resolution of the interpolated still image. Note that once the residual image is generated, the original still image is no longer needed in storage.

In step 460, the live view images are combined with the representative live view image to form a final live view image having increased dynamic range. Once this step is completed, the final live view image is interpolated back to the resolution of the (possibly cropped) still image 470. In a preferred embodiment, this interpolation step is identical to the interpolation step used in Step 450. Finally, the result of this interpolation step, the interpolated final live view image, is added to the residual image to form an improved image at still image resolution having increased dynamic range 480.

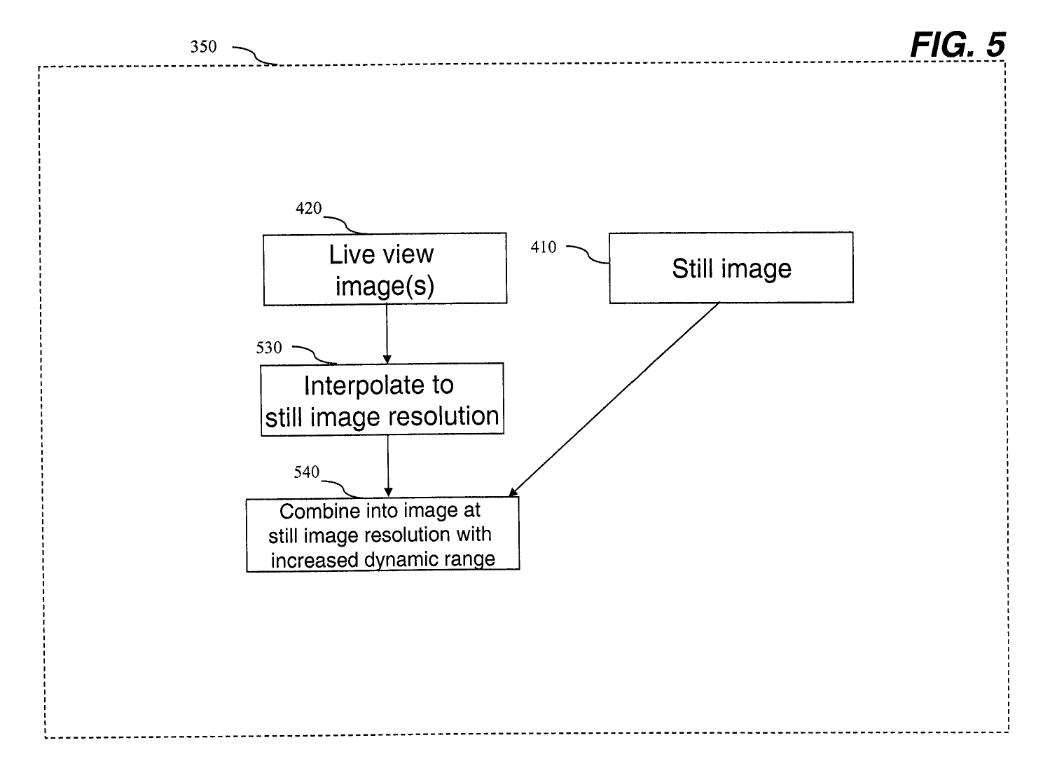

FIG. 5 describes in more detail the step of combining the live view and still images (Step 350 from FIG. 3a and FIG. 3b) according to an alternative embodiment of the present invention. The step of combining the live view and still images begins with a still image 410 and at least one live view image 420 The live view images are interpolated to be the same resolution as the still image 530. Subsequently the interpolated live view images are combined with the still image to form a final still image having increased dynamic range.

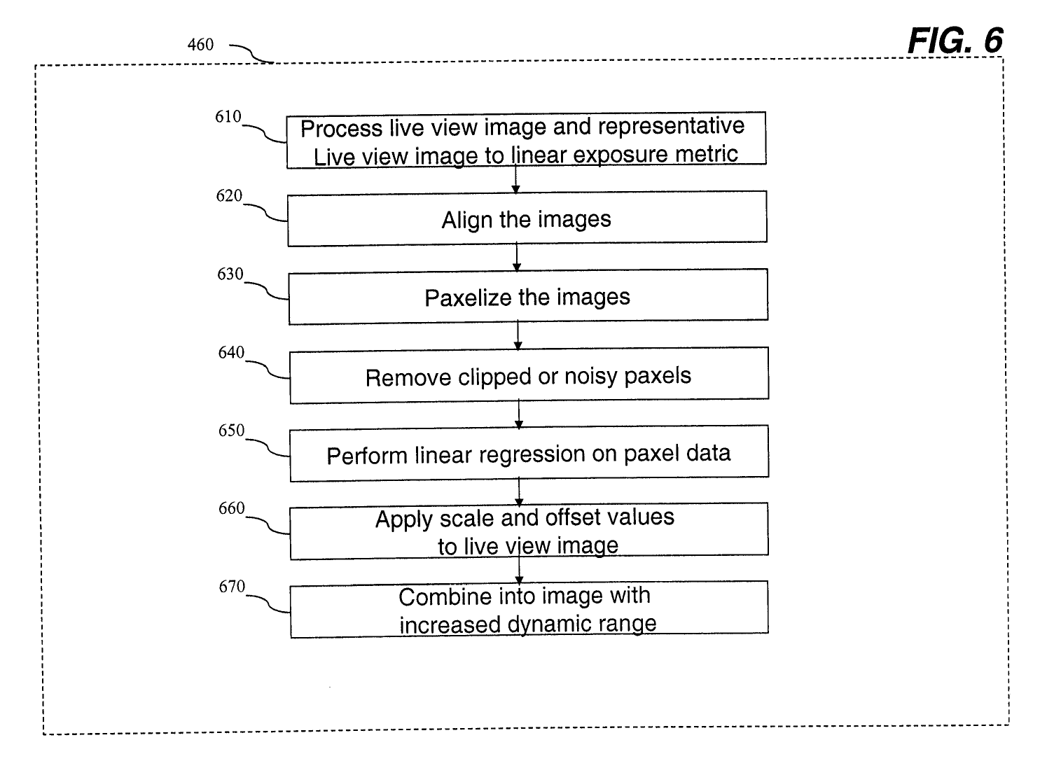

FIG. 6 describes in more detail the step of combining the live view and representative live view images into a final live view image having increased dynamic range (Step 460 from FIG. 4) according to a preferred embodiment of the present invention. To combine a live view image and a representative live view image into a single image with larger dynamic range, the live view and representative live view images are processed to be in an exposure metric 610. That is to say the pixel values are processed to be in a metric that can be traced back to relative exposure. In the preferred embodiment, that metric is linear relative exposure.

The live view and representative live view images are subsequently aligned so that both images represent the same scene content 620. As described previously, it is desirable if the multiple images capture the same scene, and there is no global or object motion occurring during the multiple captures. In the case of motion, however, an additional step of motion compensation can be included prior to the combination of the live view and representative live view images.

In one method of motion compensation, a global motion compensation step is applied to align the live view and representative live view images. Methods of global motion estimation and compensation are well-known to those of skill in the art, and any suitable method can be applied to align the live view and representative live view images. In a preferred embodiment, in the case that the images being aligned are CFA images, the motion estimation step is restricted to translational motion of an integer multiple of the CFA pattern size, such as 2×2 in the case of a Bayer pattern, to ensure that the motion-compensated images retain a Bayer pattern.

Local motion estimation and compensation can be used to replace or refine the global motion estimate. Methods of local motion estimation and compensation are well-known to those of skill in the art, and any suitable method can be applied to align the live view and representative live view images. In particular, block-based motion estimation algorithms can be used to determine motion estimates on local regions (blocks).

The next step is to create an estimate of exposure and flare. The following relationship is assumed:

Y(x,y)=ExposureDelta·X(x,y)+FlareDelta Eq. (1).

In Eq. (1), (x,y) refer to pixel coordinates, X refers to the live view image, and Y refers to the representative live view image. ExposureDelta and FlareDelta are the two unknown terms to be solved. For image data in a linear exposure metric, two images differing only in exposure can be related by a multiplicative term as represented by ExposureDelta. Remaining differences between the two images that are not modeled by a multiplicative term, such as differences in flare, can be modeled with an additional offset term, as given by FlareDelta.

In general, exposure differences between two images, and hence the ExposureDelta term, can be determined from the camera capture system, however due to variations in the performance of mechanical shutters, and other camera components, there can be a significant difference between the recorded exposure and the actual exposure of an image. To estimate the exposure and flare terms that relate the live view and representative live view images, first the live view and representative live view images are paxelized 630 or downsized with prefiltering to a small image representation (e.g. 12×8 pixels). In a preferred embodiment, the live view and representative live view images are CFA data, and the paxelized version of each image is formed using only image data from a single channel. For example, the green pixel data can be used in computing the paxelized images. Alternatively, all three channels of Bayer pattern CFA data can be used to generate luminance values for the paxelized image. In the case that the live view and representative live view images are full color images having red, green and blue values at every pixel location, the paxelized images can be formed using data from a single channel, or by computing a luminance channel from the full color image and deriving a paxelized image from the luminance image data.

The paxelized representations of the live view and representative live view images are given as X^{p}(i, j) and Y^{p}(i, j), respectively, where (i,j) are paxel coordinates. The paxelized images are vectorized and arranged into a two column array, where each row of the array contains one paxel value from X^{p} and the corresponding paxel value from Y^{p}. Next, all rows of data that contain clipped paxel values are removed. It is noted that a pixel value increases with increasing scene luminance to a point at which the pixel value no longer increases, but stays the same. This point is the clipped value. When a pixel is at the clipped value it is said to be clipped. Also all rows that contain paxel values that are considered to be dominated by noise are removed 640. The threshold used to determine if a paxel value is dominated by noise can be set based upon noise data for a given population of capture devices. A linear regression is then done on the remaining array data to compute a slope and offset 650 relating the data in the first column of the array to the data in the second column of the array. The slope represents the exposure shift (ExposureDelta); the offset represents an estimate of global flare (FlareDelta). The next step is to convert the live view image, X, to match the representative live view image, Y, with respect to exposure and flare in accordance with Eq. (1) 660. This step results in a scaled live view image. In a preferred embodiment, if the offset term, FlareDelta, is positive, the FlareDelta term is subtracted from both the representative live view image and the scaled live view image. This results in the computation of representative live view and scaled live view images having reduced flare.

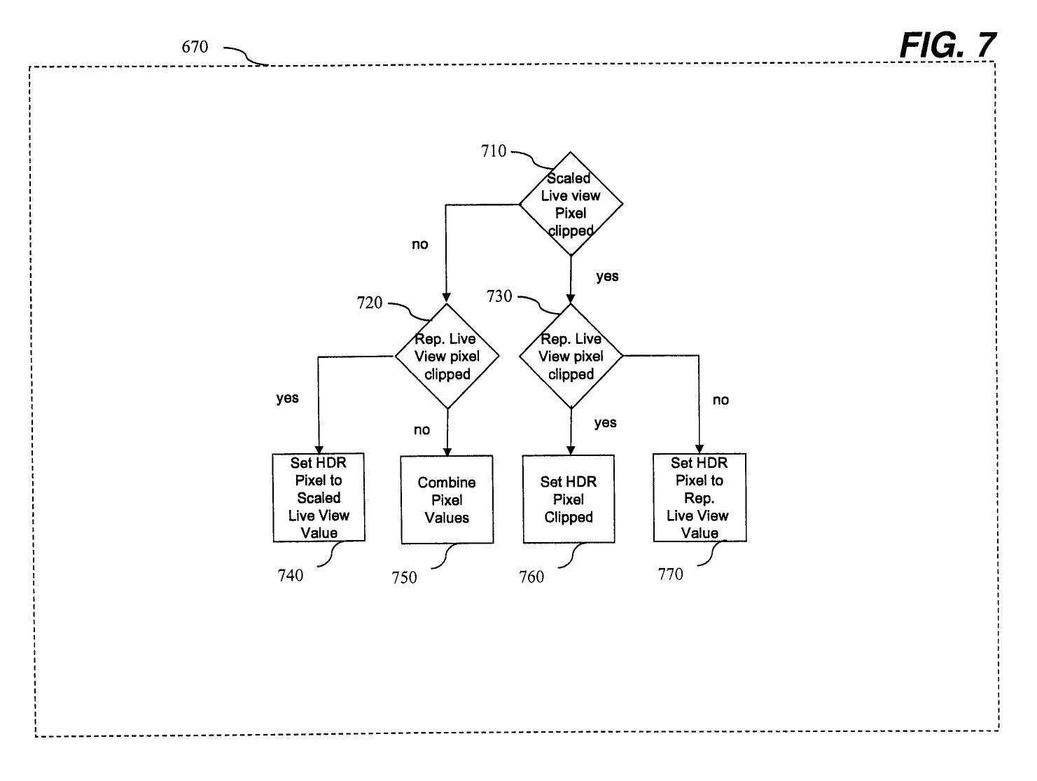

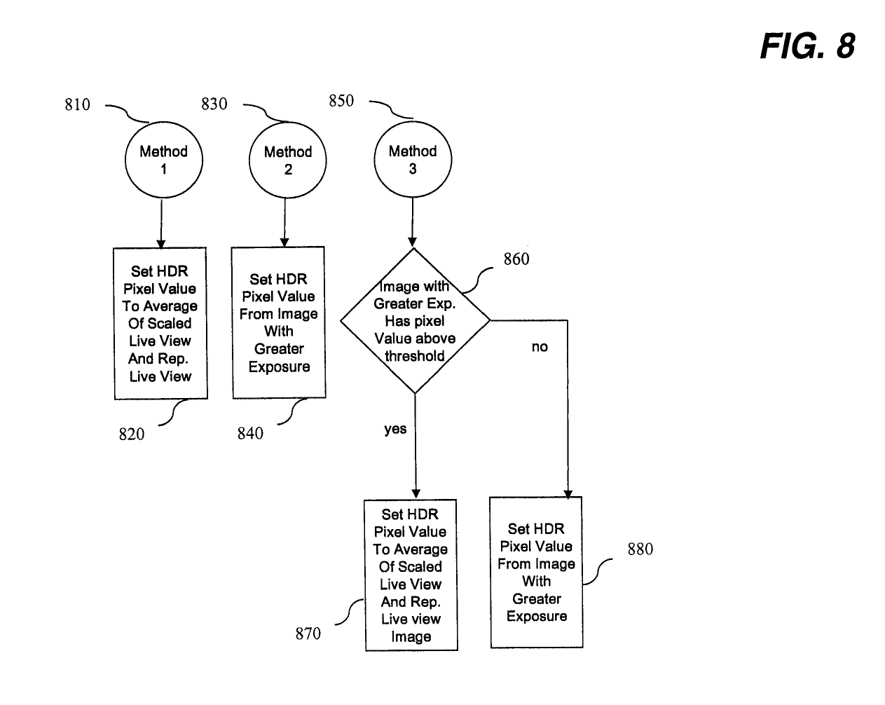

The representative live view and scaled live view images are combined to form a final live view image having increased dynamic range 670. The step of combining the representative live view image and scaled live view image is described in greater detail in FIGS. 7 and 8.

In FIG. 7, if a pixel in the scaled live view image is clipped 710 and the corresponding pixel in the representative live view image is clipped 730 then corresponding pixel in the high dynamic range image (HDR image) is set to a clipped value 760. If a pixel in the scaled live view image is clipped 710 and the corresponding pixel in the representative live view image is not clipped 730 then corresponding pixel in the HDR image is set to the corresponding representative live view image pixel value 770. If a pixel in the scaled live view image is not clipped 710 and the corresponding pixel in the representative live view image is clipped 720 then the corresponding pixel in the HDR is set to the corresponding scaled live view image pixel value 740. If a pixel in the scaled live view image is not clipped 710 and the corresponding pixel in the representative live view image is not clipped 720 then corresponding pixel in the HDR image is set based upon one of the following methods 750 as depicted in FIG. 8.

The first method 810 of combining pixels is to simply average the pixel values 820. This average can also be a weighted average, where the weights are a function of the relative noise contained in each image. Method 2 is indicated when one of the captures is of lower resolution and lower exposure 830. In this case, averaging the two images would cause a loss of detail. To prevent this, the information from the higher exposure image is always chosen 840. Method 3 describes a method where the hard logic threshold is avoided in favor of a method that “feathers in” the lower resolution, lower exposure image 850. Pixel values from the higher exposed image are compared to a threshold 860. Pixels above the threshold are combined by averaging the pixels values from the two images 870. Pixel values not above the threshold are combined using the pixel value from the image with greater exposure 880.

Returning to FIGS. 3a and 3b, once the live view and still images have been combined into an image having increased dynamic range, it can be rendered to an output space 360. For example, it can be rendered to a sRGB image by means of a tonescaling processing, such as described in U.S. Pat. No. 7,130,485 by Gindele et al., which is incorporated herein by reference. Note that step 360 can be skipped if the image is displayed on a device inherently capable of handling and displaying a high dynamic range image.

In a preferred embodiment of the invention according to FIG. 4, the live view and representative live view images are CFA images, and the final live view image having increased dynamic range is also a CFA image. In this case, the standard image processing step of CFA interpolation is performed after the high dynamic image has been produced. Alternatively, the live view and still images can be CFA interpolated initially, and all subsequent steps can be performed with full color images.

The steps illustrated in FIG. 6 to combine live view and representative live view images can also be applied to the case that the two images to be combined are the interpolated live view image and still image as in Step 540. In this case, each of the steps outlined in FIG. 6 is applied with the usage of a live view image and representative live view image replaced with the usage of an interpolated live view image and still image, respectively. Also, in this case, the output of the combining step is a high dynamic range image having the resolution of the still image.

The steps illustrated in FIG. 6 to combine live view and representative live view images can be applied multiple times in the case that there are multiple live view images having different exposures. Each live view image can have individual scale and offset values computed to relate it to the representative live view image. The final live view image can be formed as a combination of the multiple scaled live view images along with the representative live view image.

In another method of motion compensation, local motion estimation or motion detection is used to identify regions of object motion within the scene. Pixels corresponding to object motion are identified, and are processed differently in the step to combine live view and representative live view images (Step 460 in FIG. 4), or interpolated live view and still images (Step 540 in FIG. 5). In particular, since the scene content does not match among the still and live view images in regions marks as having object motion, the live view images are not used to improve the dynamic range of the still image in those regions. Methods of motion detection are well-known to those of skill in the art, and any suitable method can be applied to detect moving regions in the still and live view images.

Those skilled in the art will recognize that there are many alternative methods to the present invention.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention.

### PARTS LIST

10 Light
11 Imaging stage
12 Lens
13 Filter block
14 Iris
16 Sensor block
18 Shutter block
20 Image Sensor
22 Analog signal processor
24 A/D converter
26 Timing generator
28 Sensor stage
30 Bus
32 DSP Memory
36 Digital signal processor
38 Processing Stage
40 Exposure controller
50 System controller
52 Bus
54 Program memory
56 System memory
57 Host interface
60 Memory card interface
62 Socket
64 Memory card
68 User interface
70 Viewfinder display
72 Exposure display
74 User inputs
76 Status display
80 Video encoder
82 Display controller
88 Image display
310 Capture button to S1 block
320 Image acquisition block
330 Capture button to S2 block
335 Image capture block
340 Image capture block
350 Image combination block
360 Image rendering block
410 Still image
420 Live view image(s)
430 Resolution reduction block
440 Interpolation block
450 Residual computation block
460 Image combination block
470 Interpolation block
480 Image combination block
530 Interpolation block
540 Image combination block
610 Image processing block
620 Image alignment block
630 Image paxel forming block
640 Clipped and noisy data removal block
650 Regression block
660 Live view scaling block
670 Image combining block
710 Live view pixel clipped query
720 Representative live view pixel clipped query
730 Representative live view pixel clipped query
740 Assignment block
750 Assignment block
760 Assignment block
770 Assignment block
810 Method one block
820 Assignment block
830 Method two block
840 Assignment block
850 Method three block
860 Pixel value query
870 Assignment block
880 Assignment block

1. A method for improving the dynamic range of a captured digital image, the method comprising the steps of
(a) acquiring at least one image from the live view image stream, wherein each acquired live view image has an effective exposure and a first resolution;
(b) capturing at least one still image at an effective exposure different than each of the acquired live view images, and at a resolution higher than the first resolution; and
(c) combining the at least one live view image and the at least one still image.

2. The method as in claim 1 further comprising the step of rendering the combined image to an output space.

3. The method as in claim 1, wherein step (c) includes combining the at least one live view image and the at least one still image into a common exposure space at a dynamic range higher than the individual acquired live view images and captured still images.

4. The method as in claim 1, wherein step (a) includes automatically acquiring each image.

5. The method as in claim 1, wherein each acquired live view image has an effective exposure less than the effective exposure of the still image.

6. The method as in claim 1, wherein each acquired live view image has an effective exposure greater than the effective exposure of the still image.

7. The method as in claim 1, wherein step (a) includes acquiring a first live view image at a first effective exposure and a second live view image at a second effective exposure different from the first effective exposure.

8. The method as in claim 7, wherein a first acquired live view image has effective exposure less than the effective exposure of the still image, and a second acquired live view image has effective exposure greater than the effective exposure of the still image.

9. The method as in claim 1, wherein the combining step occurs at the resolution of the live view image.

10. The method as in claim 1, wherein the combining step occurs at the resolution of the still image.

11. The method as in claim 1, wherein step (c) further includes detecting and compensating for motion in the live view and still images.
